(19) United States
(12) Patent Application Publication
(10) Pub. No.: US 2013/0198024 A1
(43) Pub. Date: Aug. 1, 2013

(54) Method and Apparatus Pertaining to the Aggregation and Parsing of Behavioral-Event Content

(71) Applicants: Paul Sutter, San Francisco, CA (US); Stefan Petry, Menlo Park, CA (US)

(72) Inventors: Paul Sutter, San Francisco, CA (US); Stefan Petry, Menlo Park, CA (US)

(21) Appl. No.: 13/361,476

(22) Filed: Jan. 30, 2012

(51) Int. Cl. G06Q 30/08; G06F 17/30

(52) U.S. Cl. 705/26.3; 707/776; 707/E17.108

(57) ABSTRACT

A control circuit collects content for on-line behavioral events for a plurality of discrete on-line participants and then uses this identifying information to parse and aggregate that content to provide parsed, aggregated behavioral-event content that can then be offered, for example, via an on-line auction. By one approach the identifying information can serve as a basis to parse the aggregated content by industry to thereby yield, for example, search queries conducted by a variety of persons working for a variety of companies as comprise a given industry. By ensuring a statistically-significant number of sources, and by withholding the identifying information when offering the resultant parsed, aggregated content, the identities of the sources are anonymized to thereby protect and preserve the privacy of these sources.

### RELATED APPLICATION(S)

This application is related to co-pending and co-owned U.S. patent application Ser. No. 13/299,447, entitled METHOD AND APPARATUS PERTAINING TO FINANCIAL INVESTMENT QUANTITATIVE ANALYSIS SIGNAL AUCTIONS and filed Nov. 18, 2011, which is incorporated by reference in its entirety herein.

### TECHNICAL FIELD

This invention relates generally to the mining of aggregated information regarding behavioral events.

### BACKGROUND

A variety of behavioral events are regularly noted and recorded. As one example in these regards, Internet search queries entered by various individuals via their browsers are regularly aggregated in some manner or another (by, for example, the search engine service that processes the search). Such information, in turn, offers a variety of mining possibilities.

Privacy concerns, however, present various credible apprehensions in these regards. Generally speaking, privacy advocates express considerable concern when information mining includes revealing information and behaviors of identified individuals. At the same time, numerous valid research opportunities seem impossible to conduct without accounting in some way for the sources of the data inputs. These conflicting interests have likely stymied much in the way of helpful and useful research and analysis.

### BRIEF DESCRIPTION OF THE DRAWINGS

The above needs are at least partially met through provision of the method and apparatus pertaining to the aggregation and parsing of behavioral-event content described in the following detailed description, particularly when studied in conjunction with the drawings, wherein:

FIG. 1 comprises a flow diagram as configured in accordance with various embodiments of the invention;

FIG. 2 comprises a schematic view as configured in accordance with various embodiments of the invention;

FIG. 3 comprises a schematic view as configured in accordance with various embodiments of the invention;

FIG. 4 comprises a flow diagram as configured in accordance with various embodiments of the invention;

FIG. 5 comprises a block diagram as configured in accordance with various embodiments of the invention.

FIG. 6 comprises a screen shot schematic as configured in accordance with various embodiments of the invention.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a control circuit collects content for behavioral events for a plurality of discrete participants. This content includes behavioral-event content along with identifying information for the corresponding discrete on-line participants. The control circuit then uses this identifying information to parse and aggregate the behavioral-event content to provide parsed, aggregated behavioral-event content that can then be disseminated, for example, via an on-line auction, a subscription service, or otherwise.

The aforementioned identifying information can comprise, for example, one or both of Internet Protocol addresses (including portions thereof) and cookies as pertain to on-line searchers. By one approach, for example, this identifying information serves as a basis to aggregate content and/or to parse aggregated content by industry to thereby yield, for example, search queries conducted by a variety of persons working for a variety of companies as comprise a given industry. By ensuring a statistically-significant number of sources, and by withholding the identifying information when offering the resultant parsed, aggregated content, the identities of the sources are anonymized to thereby protect and preserve the privacy of these sources while also permitting a wide range of useful research and analysis to be conducted beyond what present practices would seem to otherwise permit. (As used herein, the expression “sources” will be understood to include the aforementioned individual participants, searchers, and the like, but can also include, for example, a group of participants that are grouped by a range of Internet Protocol addresses.)

These teachings will accommodate a wide variety of practices in these regards. For example, the aggregating and/or parsing of the behavioral-event content can be carried out on an industry-by-industry basis, a geographical basis, and/or as a function of time as desired. These teachings can be readily applied to further leverage the value and usefulness of a variety of existing records and data stores and can be readily scaled to accommodate essentially any number of sources, parsing criteria, and so forth.

These teachings will also accommodate various methodologies by which such parsed, aggregated content can be disseminated. By one approach, for example, this can comprise conducting an on-line auction for the parsed, aggregated behavioral-event content. In such a case, and as desired, the conduct of such an auction can include permitting a bidder, offerer, and/or other party to specify limits with respect to and/or to otherwise set conditions with respect to or otherwise based upon the identifying information.

These and other benefits may become clearer upon making a thorough review and study of the following detailed description. Referring now to the drawings, and in particular to FIG. 1, an illustrative process 100 that is compatible with many of these teachings will now be presented.

This process 100 can be carried out, for example, by any of a variety of control circuits. This can include partially or wholly-programmable platforms as are known in the art or dedicated purpose platforms as may be desired for some applications. Such architectural options are well known and understood in the art and require no further description here.

This process 100 includes the step 101 of collecting content for behavioral events (such as, but not limited to, on-line behavioral events) for a plurality of discrete participants (such as, but not limited to, on-line participants) (i.e., unique persons with or without a corresponding affiliation, such as a company affiliation, as well as companies or other non-person entities that may nevertheless have a sufficient presence to serve, in context, as a “participant”). This content can include behavioral-event content as well as identifying information for corresponding discrete on-line participants. This content can also include time stamps as correspond to individual items of content. These can comprise, for example, specific days and times of day at which the various behavioral events occurred.

By one approach the aforementioned behavioral-event content includes information regarding searches conducted by various persons. In such a case, and by way of illustration and without intending any limitations in these regards, this step 101 can comprise collecting search query content for a plurality of searchers, wherein the search query content includes some or all of the search terms as comprise the search queries of those searchers as entered via any of a variety of search engines (such as, by way of illustration, search services offered by Google, Yahoo, Bing, Wolfram/Alpha, FPO's patent search service, and so forth).

As another example, the aforementioned behavioral-event content includes information regarding particular visited websites and/or particular website page views. These teachings are highly flexible in these regards and will accommodate a wide range of behavioral events such as credit card/debit card transactions, Paypal transactions, auction bids, Tweets, blog postings, web links followed, location data (including global position system-based data), advertising spending or revenue numbers, transportation and shipping activities, supply chain data, sports and economic predictions (such as intrade.com), ad targeting data (such as Bluekai data (as offered by Blue Kai, Inc.)), pricing data, satellite imagery, and so forth.

The aforementioned identifying information can vary with the needs and/or opportunities as tend to characterize a given application setting. By one approach this identifying information can comprise, for example, information regarding Internet Protocol addresses. This can include Internet Protocol addresses (or a particular range of Internet Protocol addresses and/or particular portions of such addresses, such as domain information) for specific corresponding discrete on-line participants (such as individual searchers). As another example in these regards, this identifying information can comprise a plurality of Internet Protocol addresses as all correspond to a particular entity (for example, the Internet Protocol addresses that correspond to the range of Internet Protocol addresses that are used by a particular company).

As a further example in these regards, this identifying information can comprise information regarding one or more visited websites. Such information can include, for example, searcher cookie information. Those skilled in the art will understand that cookies are supported by hyper-text transfer protocol and generally serve to permit an origin website to send state information to a user's browser and for the browser to return state information to the origin site. The indiscriminate leveraging of cookies of course comprises an area of privacy concern and the present teachings serve to reduce such concerns as described below notwithstanding this initial gathering of such information.

At step 102 this process 100 then provides for using the identifying information to aggregate and parse the collected behavioral-event content to thereby provide parsed, aggregated behavioral-event content. When the behavioral-event content comprises search query content, this step 102 can comprise, by way of illustration, using the identifying information to parse and/or aggregate the search query content to provide parsed, aggregated search query content.

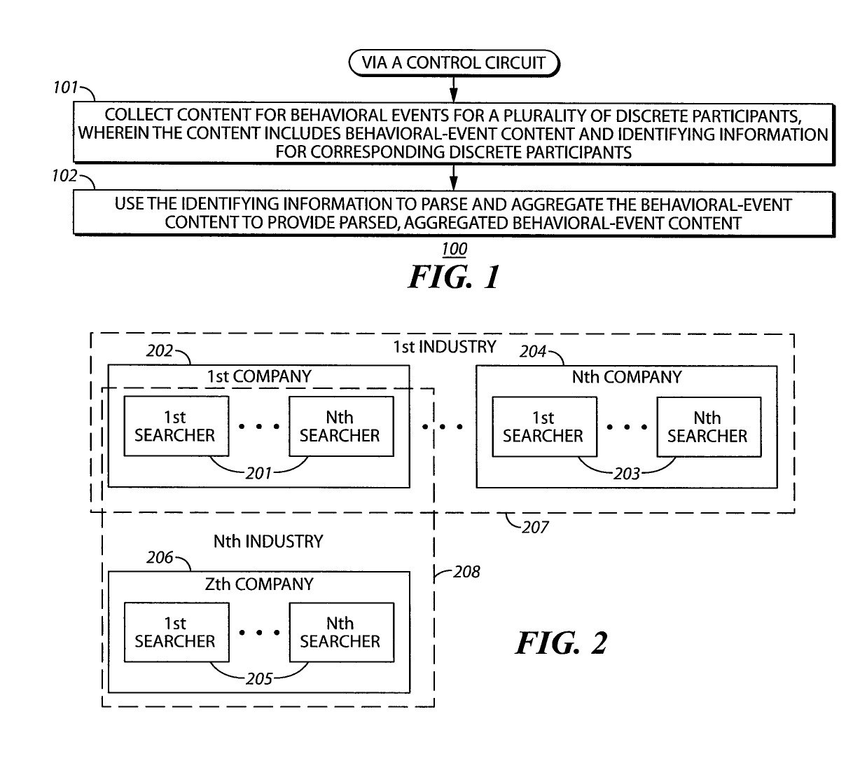

FIG. 2 provides a first illustrative example in these regards. In this example the search queries entered by a plurality of searchers are aggregated. This aggregation can cover, for example, a particular window or duration of time (such as a given week, month, or year's worth of search queries). As another example, in lieu of the foregoing or in combination therewith, this aggregation can be geographically based. In such a case, the aggregation can cover a particular municipality, state or territory, country, economic region, or such other geographic region as may be of interest.

In the illustrated example, some of the searchers 201 are employed by a first company 202, another set of searchers 203 are employed by an Nth company 204, and yet another set of searchers 205 are employed by a Zth company 206. (As used herein, “N” and “Z” will be understood to refer to integers greater than “1.” Accordingly, it will be understood that FIG. 2 illustrates essentially any number of plural companies that each harbor any number of plural searchers.) In such a case, the aggregated raw data can be immense (constituting, for example, all search query content by all searchers located at all of these companies and possibly other non-company-affiliated searchers (not shown) as well).

With continued reference to FIG. 2's example, the aforementioned parsing can comprise parsing the aggregated search query content on the basis of a particular industry. The identifying information as corresponds to these search queries can include, for example, domain information that identifies a particular company. The searchers 201 located at the first company 202, for example, may have a cookie set to COOKIE201-XXX and reside within the Internet Protocol address range for an office of a first COMPANY 202, and searchers 203 may have a cookie set to COOKIE203-XXX and reside within the Internet protocol address range for a certain office of a second COMPANY 204.

These specific companies, in turn, can be categorized as both belonging to a first industry 207. This categorization may not be directly ascertained from the identifying information (though recent opportunities to create top-level domains on essentially any basis (such as, for example, xxxxxx@companyname.industryname) may offer opportunities in these regards in the future). In such a case the industry-based correlation/categorization can be internally generated and/or acquired from an external resource that provides such information.

FIG. 2 also illustrates that the present teachings will accommodate the fact that some companies are sufficiently diversified as to qualify for inclusion in a variety of industrial categorizations. The first company 202 is also categorized here as being a part of an Nth industry 208 along with, for example, the Zth company 206. Accordingly, parsing the aggregated content to provide a first set of search queries as correspond to the first industry 207 and to separately provide a second set of search queries as correspond to the Nth industry 208 will yield search query sets that both include search queries for the searchers 201 of the first company 202.

In any event, this process 100 permits, for example, the search queries entered by searchers associated with companies that are, in turn, associated with a particular industry to be parsed from a larger aggregation of search queries. This parsing depends, in this example, upon knowing the identification information offered by the Internet Protocol addresses associated with the searchers. Having so parsed the content, however, the resultant parsed, aggregated search query information can be passed along to a party of interest without also including that identifying information.

It will further be appreciated that, presuming a statistically significant number of searchers/companies, individual searcher identities as might otherwise be possibly gleaned from the search query content itself are anonymized in these regards as well by the sheer bulk of the content.

That said, the resultant parsed, aggregated content can greatly inform a large number of useful and worthy research inquiries. Using such an approach, for example, a researcher can note that searchers conducting searches for a given industry are displaying considerable interest in a given new technology. This observation, in turn, can serve as a quantitative analyst's signal that can inform a financial decision maker's financial decisions.

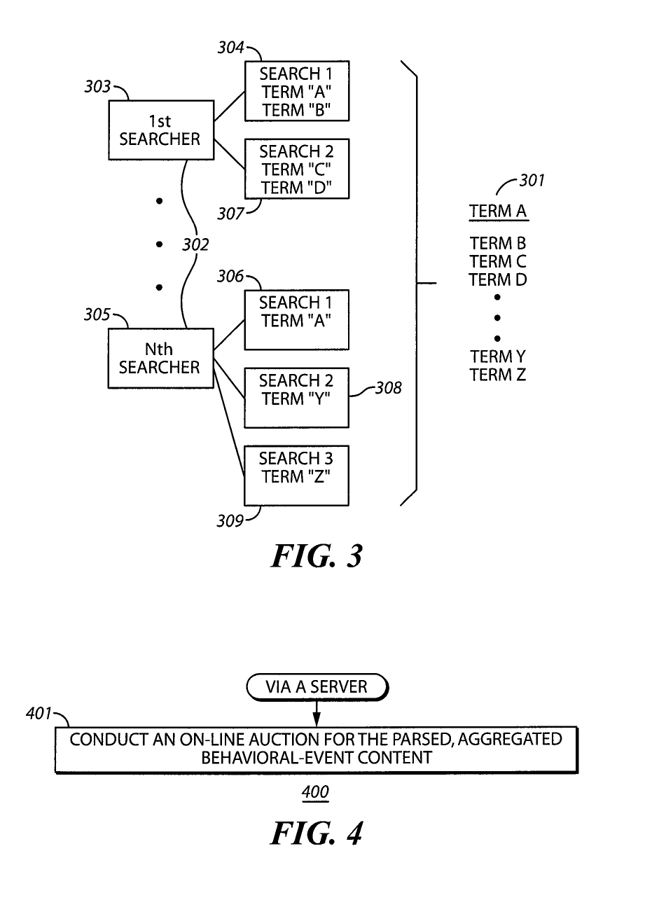

FIG. 3 provides another illustrative example in these regards. This example illustrates the parsing of aggregated search queries 301 for each of a plurality of searchers 302 who each conducted at least one search for a given specified query topic. In this example that given specified query topic is represented as term A. Here, a first searcher 303 conducted a first search 304 that had term A as well as a term B. Other searchers 302 also used this same search term including the illustrated Nth searcher 305 who also conducted a search 306 using term A. An example would be a topic based on the term “iphone.” A corresponding aggregation could aggregate users who performed searches that included the term “iphone.” Such an aggregation might be used to explore, for example, how frequently users in that group also performed searches that include the terms “antenna problem.”

In this illustrative example the parsing and aggregation comprises parsing the available content to identify searchers who used “query A” and then using the identification information for those searchers to aggregate/parse their other search queries regardless of whether those other search queries included “query A.” As a result, those parsed, aggregated results 301 include the results of a second search 307 for the first searcher 303 (i.e., query C and query D) along with the search queries for a second and third search 308 and 309 by the Nth searcher 305.

Again, as desired, those parsed, aggregated results 301 can be further disseminated without also passing along the identifying information that otherwise facilitated the aforementioned parsing and aggregation. Although these parsed, aggregated results 301 may be bereft of such identifying information, the parsed, aggregated results 301 can nevertheless provide useful information in support of corresponding research. For example, such a study can provide useful insights into the kinds of search topics that are generally shared across a population of searchers who also searched, in common, a given search topic (such as query A in this example).

As a simple illustration, such an approach will permit one to discover that searchers within a given industry who all conducted searches regarding a specific new technology also tended to conduct searches regarding the availability of a particular material. This information can, in turn, lead to conclusions regarding the necessity of availability of that material if one wishes to practice this new technology.

These teachings are highly flexible in practice. As but one illustrative example in these regards, these teachings will accommodate identifying the searchers who conducted searches using one or more specific search queries during a first time frame of interest (such as, for example, a given year) and then gathering together all of the search queries conducted by those particular searchers during some subsequent non-overlapping time frame of interest (such as, for example, a given later year).

As noted above, such parsed, aggregated behavioral-event content can be disseminated using any of a variety of dissemination methodologies. By one approach, for example, such content can be developed on a customized per-order basis per the specifications of a particular customer. As another example in these regards, such information can be provided to one or more recipients on a subscription basis (where, for example, a subscriber receives, on a weekly basis for a subscription period such as one year, a report comprising parsed, aggregated content of interest).

With reference to FIG. 4, and by way of yet another example regarding the flexibility of these teachings with respect to disseminating the resultant content, this can include a process 400 that provides the step 401 of conducting an on-line auction for such content. As one specific example in these regards, such an auction can comprise an auction that offers such parsed, aggregated information as a financial investment quantitative analysis signal.

Such an auction can of course offer access to previously parsed, aggregated content. These teachings will also accommodate, however, auctioning access to future parsed, aggregated search query content if desired. Generally speaking, for many application purposes it will be useful to use time as a parsing criterion and this can include continuous or discontinuous durations of past time as well as present and/or future time frames as well as desired.

As noted above, these teachings are readily employed in a manner that completely minimizes a view into the specifics of the parsing and/or aggregation identification information. If desired, however, the kind and/or degree to which one observes such security can be made somewhat variable. As one simple example in these regards, when conducting an on-line auction the offering party and/or the bidders can be provided with an interface that permits them to set or specify limits with respect to the amount of identifying information that will be provided to a winning bidder.

These teachings will also permit any of a variety of parties to make certain requirements regarding the identifying information that serves as an aggregating and/or parsing criteria per the foregoing. For example, the winning bidder can require that the number of companies and/or the number of unique searchers that underlie the parsed, aggregated content be such that no one cookie comprises more than two percent of the aggregation, or the offering party might require that aggregations may only be released to a buyer if the aggregation comprises, for example, at least one hundred distinct cookies or at least fifty distinct Internet Protocol addresses.

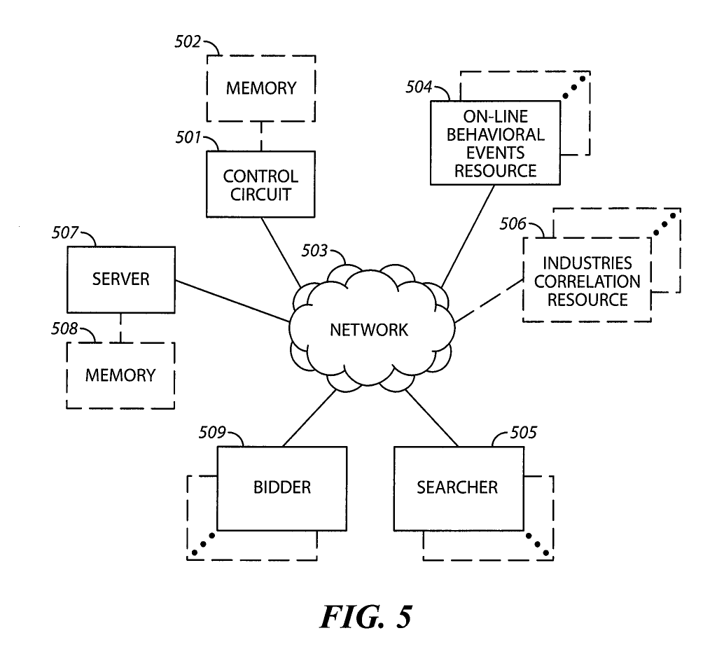

The processes described herein can be carried out using various enabling platforms. FIG. 5 illustrates some possibilities in these regards. It will be understood that no particular limitations are intended by way of the specifics of this example.

FIG. 5 depicts a control circuit 501 configured (for example, by using corresponding programming as will be well understood by those skilled in the art) to carry out one or more of the steps, actions, and/or functions described herein. By one approach this control circuit 501 couples to a memory 502. The memory 502 may be integral to the control circuit 501 or can be physically discrete (in whole or in part) from the control circuit 501 as desired. This memory 502 can also be local with respect to the control circuit 501 (where, for example, both share a common circuit board, chassis, power supply, and/or housing) or can be partially or wholly remote with respect to the control circuit 501 (where, for example, the memory 202 is physically located in another facility, metropolitan area, or even country as compared to the control circuit 501).

This memory 502 can serve, for example, to non-transitorily store the computer instructions that, when executed by the control circuit 501, cause the control circuit 501 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).) This memory 502 can also serve as appropriate to store aggregated and/or parsed content as described herein.

This control circuit 501 can communicatively couple to one or more networks 503 such as but not limited to the Internet or a credit card private data network. So configured the control circuit 501 can readily communicate with, for example, one or more on-line behavioral events resources 504 where the aforementioned behavioral events content (regarding, for example, searches conducted by various searchers 505) can be acquired to facilitate the processing described herein. As another example in these regards, such a network 503 can provide a mechanism by which the control circuit 501 contacts entities such as an industries correlation resource 506 that provides information correlating specific industries so specific corresponding companies.

As noted above a server 507 can support on-line auctions for parsed, aggregated content provided by the control circuit 501 and interface with bidders 509 as regards the conduct of those auctions. By one approach the server 507 can constitute a separate platform as suggested by FIG. 5. The present teachings will also accommodate, however, having the control circuit 501 also act as such a server if desired.

By one approach this server 507 operably couples to a memory 508 that stores, for example, instructions and information useful to the server 507 when supporting the described on-line auctions. Server platforms are generally well understood in the art, as are memories, and therefore for the sake of brevity further elaboration in these regards will not be provided here save to note that such components can each comprise, as desired, a plurality of corresponding components. As one simple illustrative example, the server platform 507 can comprise, by one approach, a so-called server farm.

As noted above, if desired, a certain amount of control over the use of the aforementioned identifying information can be selectively exercised by various of the parties who engage in the practice of these teachings. For example, these teachings will permit a party to specify a minimum number of items of identifying information to apply as an aggregation/parsing criterion.

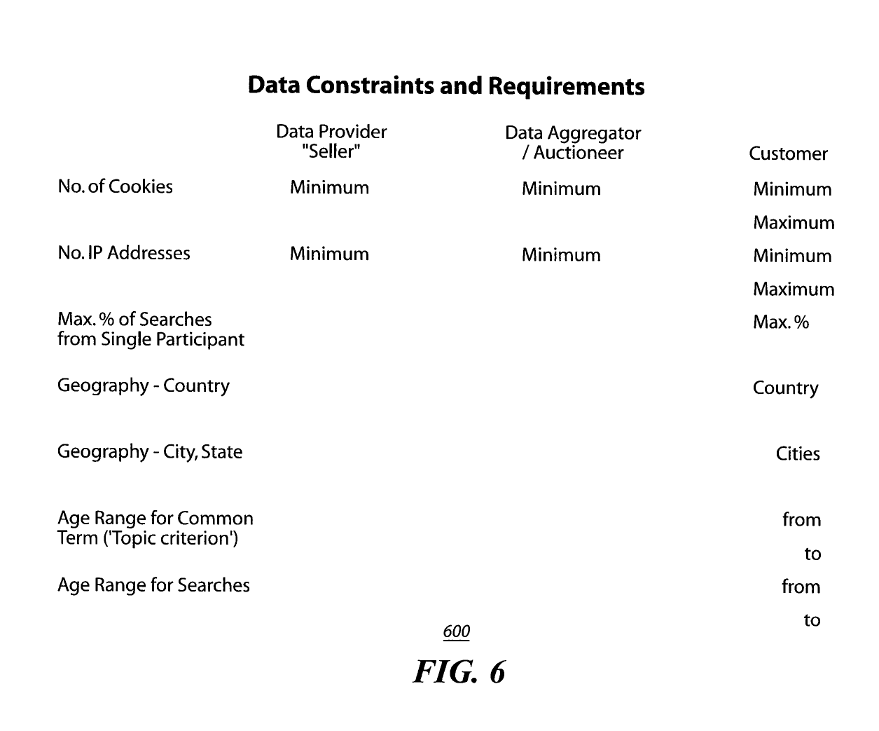

FIG. 6 provides some non-limiting, illustrative examples in these regards. This figure comprises a simple screen shot 600 (that could be used, for example, when conducting an on-line auction as described herein) that provides opportunities for various entities to enter certain stipulations regarding data constraints and requirements as can pertain to such identifying information.

The illustrated approach permits any of three categories of process participants to make corresponding entries in these regards; a data provider category (this being the category of party who provides some or all of the raw behavioral-event content), a data aggregator (or auctioneer in an appropriate application setting) (this being the category of party who carries out part or all of the aggregation/parsing described herein and/or who others provides the mechanism and/or distribution conduit by which the parsed, aggregated content is distributed to an interested party), and a customer (this being the category of party who takes delivery of the parsed, aggregated content that comprises the informational deliverable contemplated herein).

In this particular example, the data provider/seller is able to specify a minimum number of cookies and/or unique Internet Protocol addresses that correspond to the body of behavioral-event content. For example, if the data provider/seller specifies five thousand cookies, then the delivered parsed, aggregated content must represent data that derives from at least five thousand cookies. As noted above, the greater the number of unique identifiers, the greater the corresponding privacy for those represented by those unique identifiers. In this illustrative example, the data aggregator/auctioneer has a similar supported ability to specify a minimum number of cookies and/or Internet Protocol addresses. In addition, the data provider can specify, for example, that no more than N percent of the parsed, aggregated data can come from a single cookie.

The customer, however, has expanded capabilities in this example. Here, the customer can not only specify a minimum number of cookies and Internet Protocol addresses but a maximum number of such items as well. In addition, the customer can further specify a maximum percentage of behavioral-event content items that stem from a single participant as well as requirements regarding the geographic circumstances of the source content and an age range for events (such as specific search terms) that serve as an aggregating criterion and events (such as other search terms) that correlate to the aggregating criterion. These examples are of course only illustrative in nature and these teachings will readily accommodate a wide variety of flexibility and variation in these regards.

So configured, and by one approach, information regarding on-line behaviors can be aggregated and parsed as a function, at least in part, of relatively specific identifying information regarding persons and/or businesses in order to develop a wide variety of useful views, reports, signals, and the like. At the same time, the privacy of those sources is easily and thoroughly protected even as the results of the parsed, aggregated results finds its way to a variety of limited or unlimited audiences. These teachings can be readily applied in conjunction with existing data sources and hence can serve to greatly leverage the value and usability of those data sources. These teachings can also be flexibly scaled to accommodate essentially any number of searchers, parsing criteria, discrete content items, and the like.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
via a control circuit:
collecting search query content for a plurality of searchers, wherein the search query content includes search terms and identifying information for corresponding searchers;
using the identifying information to parse and aggregate the search query content to provide parsed, aggregated search query content.

2. The method of claim 1 further comprising:
via a server:
conducting an on-line auction for the parsed, aggregated search query content.

3. The method of claim 2 wherein the on-line auction comprises an auction for a financial investment quantitative analysis signal.

4. The method of claim 1 wherein the identifying information includes identifying information for a particular range of Internet Protocol addresses.

5. The method of claim 1 wherein the identifying information includes identifying information for a particular Internet domain.

6. The method of claim 1 wherein the identifying information includes a plurality of Internet Protocol addresses that all correspond to a particular entity.

7. The method of claim 1 wherein using the identifying information to parse and aggregate the search query content to provide parsed, aggregated search query content comprises, at least in part, aggregating the search query content by industry.

8. The method of claim 1 wherein using the identifying information to parse and aggregate the search query content to provide parsed, aggregated search query content comprises, at least in part, aggregating the search query content by at least one search term of interest such that the parsed, aggregated search query content comprises various search terms searched by searchers who commonly searched the search term of interest.

9. The method of claim 1 wherein using the identifying information to parse and aggregate the search query content to provide parsed, aggregated search query content comprises, at least in part, aggregating the search query content by geography.

10. The method of claim 1 wherein the parsed, aggregated search query content does not include the identifying information for corresponding searchers.

11. The method of claim 1 wherein using the identifying information to parse and aggregate the search query content to provide parsed, aggregated search query content comprises aggregating search queries for a statistically significant number of searchers to thereby anonymize searcher identities as may otherwise be gleaned from the search query content.

12. The method of claim 1 further comprising disseminating the parsed, aggregated search query content by, at least in part, permitting a party to specify a minimum number of items of identifying information to apply as an aggregation/parsing criterion.

13. The method of claim 12 wherein the minimum number of items of identifying information correspond to at least one of:
a minimum number of cookies;
a minimum number of different Internet Protocol addresses;
a minimum number of different Internet Protocol addresses from within a specified range of Internet Protocol addresses.

14. The method of claim 1 further comprising disseminating the parsed, aggregated search query content by, at least in part, permitting a party to specify at least one of a maximum number and proportion of behavioral events to include from a single searcher.

15. The method of claim 1 wherein using the identifying information to parse and aggregate the search query content to provide parsed, aggregated search query content further comprises, at least in part, aggregating the search query content as a function of time.

16. The method of claim 1 wherein using the identifying information to parse and aggregate the search query content to provide parsed, aggregated search query content comprises using both Internet Protocol address information and searcher cookies to parse and aggregate the search query content to provide parsed, aggregated search query content that itself lacks Internet Protocol address information and searcher cookie content and to disseminate such aggregated content with the Internet Protocol address information and searcher cookie information removed form the data.

17. The method of claim 1 further comprising conducting an on-line auction for the parsed, aggregated search query content that includes auctioning access to future parsed, aggregated search query content.

18. A method comprising:
via a control circuit:
collecting content for behavioral events for a plurality of discrete participants, wherein the content includes behavioral-event content and identifying information for corresponding discrete participants;
using the identifying information to parse and aggregate the behavioral-event content to provide parsed, aggregated behavioral-event content.

19. The method of claim 18 further comprising:
via a server:
conducting an on-line auction for the parsed, aggregated behavioral-event content.

19. The method of claim 18 wherein the behavioral-event content includes information regarding a visited website.

20. The method of claim 18 wherein the identifying information comprises at least one of both Internet Protocol identification information and cookies as pertain to the discrete participants.

21. The method of claim 18 wherein the behavioral events comprise on-line behavioral events.
